(19) United States
(12) Patent Application Publication
(10) Pub. No.: US 2016/0105896 A1
(43) Pub. Date: Apr. 14, 2016

(54) System and Method for Link Adaptation

(71) Applicant: Huawei Technologies Co., Ltd., Shenzhen (CN)

(72) Inventors: Alireza Bayesteh, Ottawa (CA); Hosein Nikopour, San Jose, CA (US); Jianglei Ma, Ottawa (CA); Zhihang Yi, Ottawa (CA)

(21) Appl. No.: 14/512,138

(22) Filed: Oct. 10, 2014

(51) Int. Cl. H04W 72/08; H04W 72/04; H04J 11/00; H04L 1/00

(52) U.S. Cl. CPC H04W 72/082; H04L 1/0004; H04W 72/0466; H04J 11/00

(57) ABSTRACT

A method for link adaptation in a wireless communications system includes deriving a range of post-processing signal to interference plus noise ratio (SINR) values for a communications channel using a first layer in the communications channel available for communications, the range of post-processing SINR values derived in accordance with a channel estimate of the communications channel, interference information about the communications channel, and signature information. The method also includes selecting a modulation and coding scheme (MCS) in accordance with the range of post-processing SINR values to establish a first channel quality index (CQI) vector, adjusting the first CQI vector in accordance with information regarding operating conditions in the wireless communications system to produce an adjusted CQI vector, and transmitting the adjusted CQI vector to a second communications device.

### TECHNICAL FIELD

The present disclosure relates generally to digital communications, and more particularly to a system and method for link adaptation.

### BACKGROUND

In general, link adaptation involves the matching of a modulation scheme, a coding scheme, as well as other signal and/or protocol parameters to the condition of a communications channel between a transmitting device and a receiving device. The matching of the modulation scheme, the coding scheme, as well as the other parameters helps to improve overall communications performance.

### SUMMARY OF THE DISCLOSURE

Example embodiments of the present disclosure which provide a system and method for link adaptation.

In accordance with an example embodiment of the present disclosure, a method for link adaptation in a wireless communications system is provided. The method includes deriving, by a first communications device, a range of post-processing signal to interference plus noise ratio (SINR) values for a communications channel using a first layer in the communications channel available for communications, the range of post-processing SINR values derived in accordance with a channel estimate of the communications channel, interference information about the communications channel, and signature information. The method also includes selecting, by the first communications device, a modulation and coding scheme (MCS) in accordance with the range of post-processing SINR values to establish a first channel quality index (CQI) vector, and adjusting, by the first communications device, the first CQI vector in accordance with information regarding operating conditions in the wireless communications system to produce an adjusted CQI vector. The method further comprises transmitting, by the first communications device, the adjusted CQI vector to a second communications device.

In accordance with another example embodiment of the present disclosure, a method for operating a first communications device is provided. The method includes deriving, by the first communications device, a range of post-processing signal plus interference to noise ratio (SINR) values for a communications channel using a first layer in the communications channel available for communications, the range of post-processing SINR values derived in accordance with a channel estimate of the communications channel, interference information about the communications channel, and signature information. The method includes selecting, by the first communications device, a modulation and coding scheme (MCS) in accordance with the range of post-processing SINR values to establish a first channel quality index (CQI) vector, and transmitting, by the first communications device, the first CQI vector to a second communications device.

In accordance with another example embodiment of the present disclosure, a method for operating a second communications device is provided. The method includes receiving, by the second communications device, a first channel quality index (CQI) vector including a modulation and coding scheme (MCS) of a communications channel between the second communications device and a first communications device. The method also includes adjusting, by the second communications device, the first CQI vector in accordance with information regarding operating conditions in a wireless communications system to produce an adjusted CQI vector, and transmitting, by the second communications device, the adjusted CQI vector to the first communications device.

In accordance with another example embodiment of the present disclosure, a method for link adaptation in a wireless communications system is provided. The method includes receiving, by a first communications device, a channel quality report from a second communications device, and selecting, by the first communications device, an entry from a link adaptation table in accordance with the channel quality report, wherein the link adaptation table includes a plurality of entries for channel parameters, and wherein the channel parameters include a number of layers and modulation and coding scheme (MCS) levels. The method also includes communicating, by the first communications device, with the second communications device in accordance with the selected entry.

In accordance with another example embodiment of the present disclosure, a communications device is provided. The communications device includes a processor, and a transmitter operatively coupled to the processor. The processor derives a range of post-processing signal to interference plus noise ratio (SINR) values for a communications channel using a first layer in the communications channel available for communications, the range of post-processing SINR values are derived in accordance with a channel estimate of the communications channel, interference information about the communications channel, and signature information, selects a modulation and coding scheme (MCS) in accordance with the range of post-processing SINR values to establish a first channel quality index (CQI) vector, and adjusts the first CQI vector in accordance with information regarding operating conditions in a wireless communications system to produce an adjusted CQI vector. The transmitter transmits the adjusted CQI vector to a second communications device.

One advantage of an embodiment is that the example embodiments present a low complexity mechanism for link adaptation. Therefore, the implementation of the example embodiments do not require significant processing and/or communicating resources, which would negatively impact the overall communications system performance.

A further advantage of an embodiment is that the example embodiments permit link adaptation in low density signature (LDS) and/or sparse code multiple access (SCMA) communications systems.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system according to example embodiments described herein;

FIG. 2a illustrates a high-level view of an example LDS and/or SCMA link adaptation mechanism according to example embodiments described herein;

FIG. 2b illustrates an example LUT according to example embodiments described herein;

FIG. 2c illustrates a graphical representation of an example LUT according to example embodiments described herein;

FIG. 3 illustrates a detailed view of an example LDS and/or SCMA link adaptation system for a FDD communications system according to example embodiments described herein;

FIG. 4a illustrates a flow diagram of example operations occurring in a UE as the UE participates in link adaptation according to example embodiments described herein;

FIG. 4b illustrates a flow diagram of example operations occurring in an eNB as the eNB participates in link adaptation according to example embodiments described herein;

FIG. 5 illustrates a detailed view of an example LDS and/or SCMA link adaptation system for a TDD communications system according to example embodiments described herein;

FIG. 6 illustrates a flow diagram of example operations occurring in an eNB as the eNB performs link adaptation in a TDD communications system according to example embodiments described herein;

FIG. 7a illustrates a flow diagram of example operations occurring in a transmitting device as the transmitting device communicates with a receiving device according to example embodiments described herein;

FIG. 7b illustrates a flow diagram of example operations occurring in a receiving device as the receiving device communicates with a transmitting device according to example embodiments described herein;

FIG. 8 illustrates an example first communications device according to example embodiments described herein; and

FIG. 9 illustrates an example second communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to link adaptation. For example, a first communications device derives a range of post-processing signal to interference plus noise ratio (SINR) values for a communications channel using a first layer in the communications channel available for communications, the range of post-processing SINR values derived in accordance with a channel estimate of the communications channel, interference information about the communications channel, and signature information. The first communications device also selects a modulation and coding scheme (MCS) in accordance with the range of post-processing SINR values to establish a first channel quality index (CQI) vector, adjusts the first CQI vector in accordance with information regarding operating conditions in the wireless communications system to produce an adjusted CQI vector, and transmits the adjusted CQI vector to a second communications device.

The present disclosure will be described with respect to example embodiments in a specific context, namely low density signature (LDS) and/or sparse code multiple access (SCMA) communications systems that perform link adaptation to improve overall communications system performance. The disclosure may be applied to LDS and/or SCMA standards compliant communications systems, such as those that are compliant with Third Generation Partnership Project (3GPP), IEEE 802.11, and the like, technical standards, and LDS and/or SCMA non-standards compliant communications systems, that use link adaptation to improve overall communications system performance.

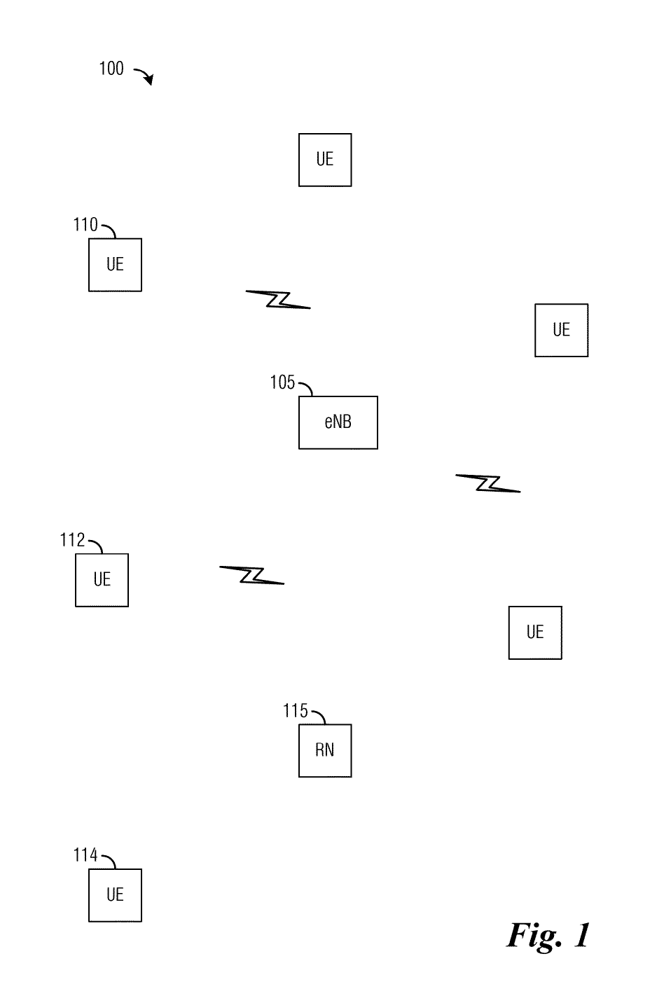

FIG. 1 illustrates an example communications system 100. Communications system 100 includes an eNB 105 serving a plurality of UEs, such as UE 110, UE 112, and UE 114. In general, communications to and from a UE pass through eNB 105. However, in a machine-to-machine (M2M) mode, UEs may be able to communicate directly without going through eNB 105. Communications system 100 may also include a relay node (RN) 115. RN 115 may use network resources of eNB 105 to help improve coverage and overall performance. As shown in FIG. 1, RN 115 may serve UE 114 to help improve coverage for UE 114. Furthermore, eNB 105 and RN 115 may simultaneously transmit to UE 114 to further improve overall performance.

It is noted that an eNB may also be commonly referred to as a base station, NodeB, controller, communications controller, and the like. Similarly, a UE may also be commonly referred to as a mobile station, mobile, user, subscriber, terminal, and the like.

While it is understood that communications systems may employ multiple eNBs capable of communicating with a number of stations, only one eNB, one RN, and a number of UEs are illustrated for simplicity.

In an LDS or a SCMA communications system, data is spread in accordance with a LDS spreading signature, or a SCMA codeword, respectively. LDS and SCMA are used for multiplexing different layers of data. In general, a layer refers to a stream of data. Layer, data layer, layer of data, stream, and data stream may be used interchangeably. LDS uses repetitions of the same symbol on layer-specific nonzero position in time or frequency. As an example, in LDS-OFDM a constellation point is repeated (with some possible phase rotations) over nonzero frequency tones of a LDS block. SCMA is a generalization of LDS where a multidimensional codebook is used to spread data over tones without necessarily repeating symbols.

SCMA is a modulation technique that encodes data streams, such as binary data streams into multidimensional codewords selected from SCMA codebooks. SCMA directly encodes the data stream into multidimensional codewords and circumvents quadrature amplitude modulation (QAM) bits to symbol mapping, which may lead to coding/shaping gain over conventional QAM modulation. Notably, SCMA encoding techniques convey data streams using a multidimensional codeword rather than a QAM symbol.

Additionally, SCMA encoding provides multiple access through the use of different codebooks for different multiplexed layers, as opposed to the use of different spreading sequences for difference multiplexed layers, e.g., a LDS signatures in LDS, as is common in conventional CDMA encoding. Furthermore, SCMA encoding typically uses codebooks with sparse codewords that enable receivers to use low complexity algorithms, such as message passing algorithms (MPA), to detect respective codewords from combined codewords received by the receiver, thereby reducing processing complexity in the receivers.

Due to the non-linear nature of SCMA, link adaptation is not trivial. Therefore, there is a need to develop a system and method for link adaptation in LDS and/or SCMA communications systems that are low complexity and/or efficient.

Code division multiple-access (CDMA) is a multiple access technique in which data symbols are spread out over orthogonal and/or near orthogonal code sequences. Traditional CDMA encoding is a two-step process in which a binary code is mapped to a QAM symbol before a spreading sequence is applied. While traditional CDMA encoding can provide relatively high data rates, new techniques/mechanisms for achieving even higher data rates are needed to meet the ever-growing demands of next-generation wireless networks. LDS is a form of CDMA used for multiplexing different layers of data. LDS uses repetitions of the same symbol on layer-specific nonzero position in time or frequency. As an example, in LDS-orthogonal frequency division multiplexing (OFDM) (LDS-OFDM) a constellation point is repeated (with some possible phase rotations) over nonzero frequency tones of a LDS block. SCMA is a codebook-based non-orthogonal multiplexing technique realized by super-imposing of multi-dimensional codewords selected form SCMA codebooks. Instead of spreading of QAM symbols as in LDS, coded bits are directly mapped to multi-dimensional sparse complex codewords. A major benefit of SCMA codebooks is the shaping gain of multi-dimensional constellations over repetition coding of LDS spreading. SCMA is classified as a waveform/modulation and multiple access scheme. SCMA codewords are laid over multi-carrier tones such as OFDM. In SCMA overloading is achievable with moderate complexity of detection thanks to the sparseness of SCMA codewords. SCMA can show noticeable gain over LDS especially for larger constellation sizes where the gain of constellation shaping is potentially larger. Even though LDS may show poor link performance for larger constellation orders, it provides system advantages due to its spreading and overloading capabilities. Interference whitening, open-loop user multiplexing and massive connectivity are some examples showing the benefit of LDS from system point of view. SCMA is a spreading and multiplexing technique that offers all the system benefits of LDS, while it maintains or even improves the link performance in comparison with OFDMA. Therefore, SCMA brings the link advantages of OFDMA and system advantages of LDS all altogether.

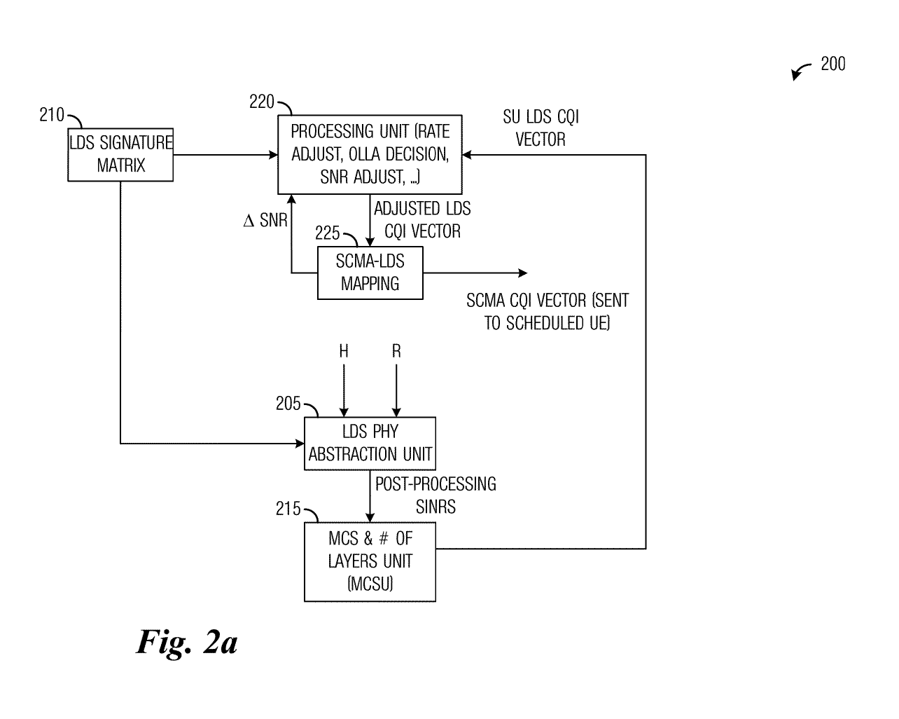

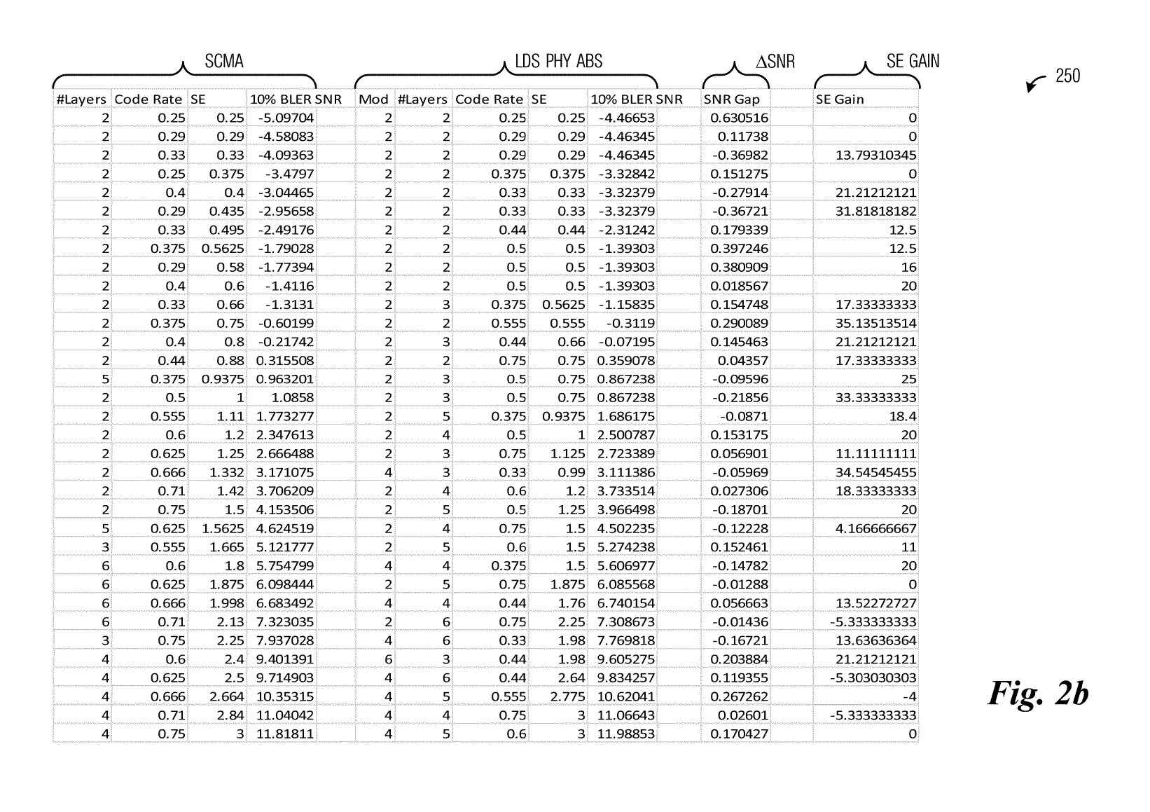

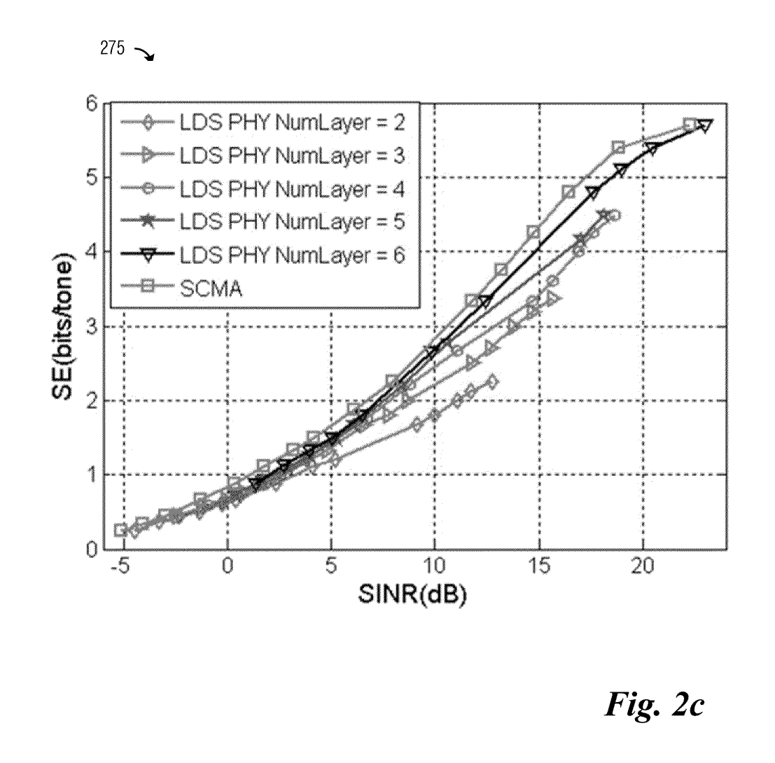

FIG. 2a illustrates a high-level view of an example LDS and/or SCMA link adaptation mechanism 200. Link adaptation mechanism 200 may be implemented in a centralized manner or a distributed manner to support link adaptation of a communications channel between a first communications device (e.g., an eNB) and a second communications device (e.g., a UE). Link adaptation mechanism 200 may be implemented in the first communications device, or a combination of both the first communications device and the second communications device. Link adaptation mechanism 200 may be implemented in a communications system that utilizes frequency division duplexing (FDD) and/or time division duplexing (TDD).

Link adaptation mechanism 200 may include a communications device derive one or more post-processing signal to interference plus noise (SINR) values using a LDS physical layer (PHY) abstraction unit 205. LDS PHY abstraction unit 205 may have as input an estimate of a communications channel between the first communications device and the second communications device (denoted H) and interference information regarding the communications channel (denoted R). LDS PHY abstraction unit 205 may also have as input LDS signature information as provided by a LDS signature matrix 210. As an example, the LDS signature information may include LDS signature assignments for users (e.g., UE) in the communications system.

According to an example embodiment, LDS PHY abstraction unit 205 may generate multiple post-processing SINR values for the communications channel. In general, the communications channel may support a maximum number of layers, with each layer corresponding to a simultaneous transmission associated with a transmission antenna, the transmitted layers being multiplexed in the code domain. LDS PHY abstraction unit 205 may generate a post-processing SINR value for each number of layers up to the maximum number of layers. As an illustrative example, if the communications channel can support up to a maximum number of 5 layers, LDS PHY abstraction unit 205 may derive a post-processing SINR value for the communications channel with 1 layer, a post-processing SINR value for the communications channel with 2 layers, a post-processing SINR value for the communications channel with 3 layers, a post-processing SINR value for the communications channel with 4 layers, and a post-processing SINR value for the communications channel with 5 layers. It is noted that although the discussion discloses the derivation of the post-processing SINR values for each possible number of layers between one and the maximum number of layers, it may be possible for the example embodiments to derive the post-processing SINR values for a subset of the possible number of layers. As an example, if the communications channel can support up to a maximum number of 5 layers, LDS PHY abstraction unit 205 may derive post-processing SINR values for 2, 3, 4, and 5 layers, for 2, 3, and 4 layers, for 3, 4, and 5 layers, for 2, 3, and 5 layers, for 1, 3, and 5 layers, for 2, and 3 layers, for 2, and 4 layers, and the like.

According to an example embodiment, the derivation of the post-processing SINR values from H, R, and the LDS signature information may be described as follows:

i. For each number of layers (ranging from 1 to J, with J being the maximum number of layers), calculate an open-loop capacity for an n-th LDS block as expressed

C_{L}^{open}(n)=log|I+H_{L}(n)R(n)⁻¹H_{L}^{H}(n)|,

where H_{L}(n)=diag(h(n))S_{L}, h(n) is the channel vector of allocated orthogonal frequency division multiplexed (OFDM) tones for the n-th LDS block, S_{L} is the first L columns of S, and S is the LDS signature matrix.

ii. The post-processing SINR values (denoted γ_{L}) for the L number of layers may be derived from the open-loop capacity using a pre-defined function. Examples of pre-defined function may be expressed as

$${γ}_{L} = f ( {\{ \frac{{C}_{L}^{open} ( n )}{L} \}}_{n = 1}^{N} ) .$$

As an illustrative example,

$${γ}_{L} = EESM ( {\{ \frac{{C}_{L}^{open} ( n )}{L} \}}_{n = 1}^{N} ) ,$$

where EESM( ) is an exponential effective signal to noise ratio (SNR) mapping function.

A modulation and coding scheme (MCS) and number of layers unit 215, or simply MCSU 215, may process the post-processing SINR values to select a MCS and a number of layers for the communications channel. The MCS and the number of layers for the communications channel may be referred to as a LDS CQI vector. In other words, MCSU 215 may use the post-processing SINR values produced by LDS PHY abstraction unit 205 to select a LDS CQI vector. As an illustrative example, the LDS CQI vector may include a MCS (or a SINR) and the number of layers chosen for the communications channel.

According to an example embodiment, the selection of the LDS CQI vector may be described as follows:

i. Determine the number of layers (denoted L*). The determination of the number of layers may be performed using short-term information, e.g., L*=arg max_{L} L log(1+γ_{L}), or long-term geometry.

ii. Determine the MCS. The determination of the MCS may be performed using a mapping similar to the mapping of the post-processing SINR values to an orthogonal frequency division multiple access (OFDMA) MCS using an OFDMA MCS table. As an illustrative example, the mechanism used in OFDMA MCS mapping may be reused.

The LDS CQI vector may be provided to a processing unit 220. Processing unit 220 may adjust the LDS CQI vector in accordance with the LDS signature information from LDS signature matrix 210. Processing unit 220 may adjust the LDS CQI vector with information such as open-loop link adaptation information, UE pairing information, power allocation information, and the like. In general, processing unit 220 may adjust the LDS CQI vector with additional communications information that may not be readily available to MCSU 215. Processing unit 220 may produce an adjusted LDS CQI vector.

If the communications system uses LDS, the adjusted LDS CQI vector may be provided to the second communications device (such as a UE) to assist the second communications device improve its decoding performance. If the communications system uses SCMA, the adjusted LDS CQI may be provided to a SCMA-LDS mapping unit 225 to map the adjusted LDS CQI vector to a SCMA CQI vector. The SCMA CQI vector may be provided to the second communications device.

SCMA-LDS mapping unit 225 may produce a SCMA CQI vector that includes a MCS (e.g., 4-point, 8-point, 16-point, and the like, SCMA constellations), a number of layers (typically greater than or equal to 2, depending on factors, such as spreading factor, overloading factor, and the like), a code rate (that usually within the same range as in OFDMA). It is noted that for some SNR ranges, it may be possible to fall back to OFDMA operation. SCMA-LDS mapping unit 225 may also provide information regarding a change in SINR due to the mapping. According to an example embodiment, SCMA-LDS mapping unit 225 may be implemented using a look-up table (LUT). FIG. 2b illustrates a example LUT 250. LUT 250 may be an example of a LUT used in SCMA-LDS mapping unit 225. In general, elements of LUT 250 may be selected so that the LDS CQI vector and the SCMA CQI vector results in substantially the same error rate, such as block error rate, bit error rate, packet error rate, and the like. In another embodiment, SCMA-LDS LUT can be defined based on link-level spectral efficiency (SE) comparison between SCMA and LDS with different number of layers for each SIMO SINR value γₛᵢₘₒ.

FIG. 2c illustrates a graphical representation of an example graphical LUT 275. LUT 275 may have as input post-processing SINR per layer. Using the post-processing SINR per layer, it may be possible to determine a single input multiple output (SIMO) SINR from the following formula:

$${log}_{2} ( 1 + {γ}_{lds} ) = \frac{1}{J} {log}_{2} det ( I + \frac{{γ}_{simo}}{J} {S}_{J}^{H} {S}_{j} ) ,$$

where J denotes the number of layers and S_{J} denotes the first J columns of S, and S is the spreading matrix. LUT 275 may provide the mapping of spectral efficiency between SCMA and a corresponding LDS curve for a particular number of layers J for each SIMO SINR value. In addition, LUT 275 may provide the SCMA CQI vector to be signaled to the scheduled UE(s). It is noted that the formula is intended for discussion purposes and other formulas may be used.

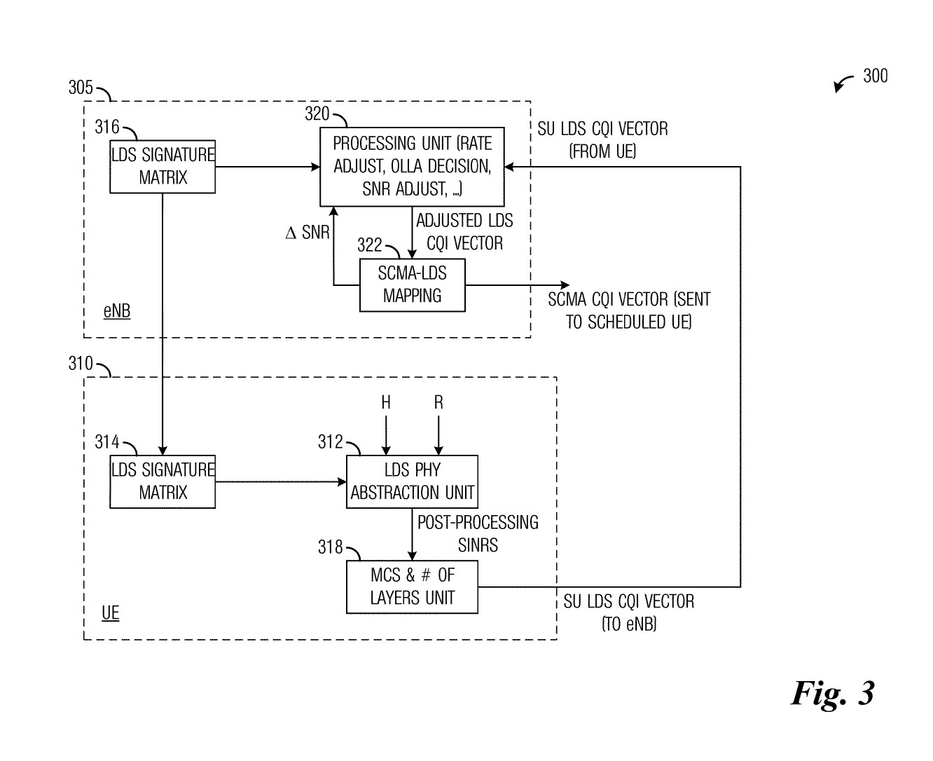

FIG. 3 illustrates a detailed view of an example LDS and/or SCMA link adaptation system 300 for a FDD communications system. Since downlink communications channels (transmissions originating at an eNB and ending at a UE) and uplink communications channels (transmissions originating at a UE and ending at an eNB) in a FDD communications system occur in different frequency bands that may be far apart in frequency, the communications channels (the uplink and the downlink channels) may have very different channel condition. Therefore, the estimation of the communications channel (H) and the interference information (R) may need to be done at the UE. As shown in FIG. 3, link adaptation system 300 includes an eNB 305 and a UE 310.

According to an example embodiment, a LDS PHY abstraction unit 312 in UE 310 may obtain the channel estimate of the communications channel (H) and the interference information (R) for a communications channel by measuring transmissions made by eNB 305. As an illustrative example, UE 310 may measure transmissions of pilot signals, reference signals, and the like, transmitted by eNB 305 to estimate the communications channel and obtain the interference information. LDS PHY abstraction unit 312 may derive post-processing SINR values from H and R, as well as LDS signature information stored in LDS signature matrix 314 that may be provided by eNB 305. A MCSU 318 may select a LDS CQI vector in accordance with the post-processing SINR values. UE 310 may feedback the LDS CQI vector to eNB 305. As an example, UE 310 may feedback an index corresponding to the LDS CQI vector to eNB 305. It is noted that it is shown in FIG. 3 that UE 310 feeds back the LDS CQI vector (or an indicator thereof). However, in alternative example embodiments, UE 310 may feedback the post-processing SINR values (or an indicator thereof) or H and R values (or indicators thereof).

According to an example embodiment, a processing unit 320 in eNB 305 may adjust the LDS CQI vector provided by UE 310. The adjustment performed by processing unit 320 may utilize information typically not available to UE 310 when it was selecting the LDS CQI vector, including open-loop link adaptation information, UE pairing information, power allocation information, and the like. If the communications system uses LDS, the adjusted LDS CQI vector may be provided to UE 310 to assist UE 310 improve its decoding performance. If the communications system uses SCMA, the adjusted LDS CQI may be provided to a SCMA-LDS mapping unit 322 to map the adjusted LDS CQI vector to a SCMA CQI vector. The SCMA CQI vector may be provided to UE 310. SCMA-LDS mapping unit 322 may be implemented using a LUT, such as ones shown in FIGS. 2b and 2c.

If UE 310 feeds back the post-processing SINR values (or an indicator thereof) or H and R values (or indicators thereof), FIG. 3 may be modified to reflect changes in eNB 305 and UE 310. As an example, if UE 310 feeds back the post-processing SINR values (or an indicator thereof), MCSU 310 may be located in eNB 305 and not UE 310. Alternatively, eNB 305 may implement its own MCSU while MCSU 310 remains in UE 310. Similarly, if UE 310 feeds back H and R values (or indicators thereof), LDS PHY abstraction unit 312 and MCSU 318 may be located in eNB 305 and not UE 310. Alternatively, eNB 305 may implement its own LDS PHY abstraction unit MCSU while LDS PHY abstraction unit 312 and MCSU 318 remain in UE 310.

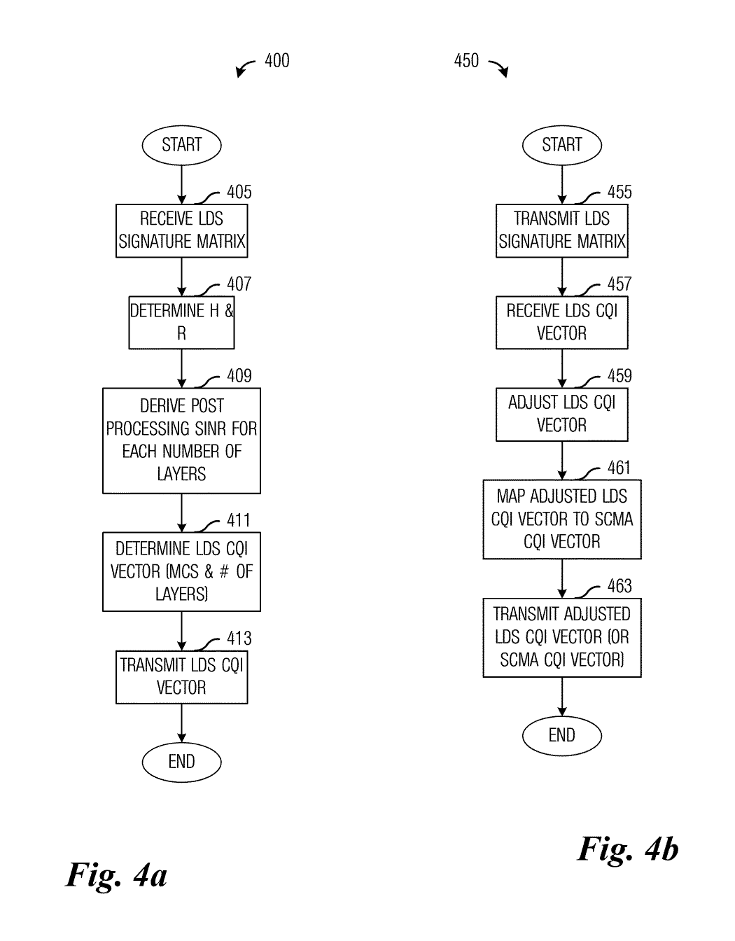

FIG. 4a illustrates a flow diagram of example operations 400 occurring in a UE as the UE participates in link adaptation. Operations 400 may be indicative of operations occurring in a UE, such as UE 310, as the UE participates in link adaptation.

Operations 400 may begin with the UE receiving a LDS signature matrix (block 405). According to an example embodiment, the UE may receive the LDS signature matrix upon attachment with an eNB. Furthermore, if changes are made to the LDS signature matrix, the eNB may transmit changes to the LDS signature matrix to the UE. The UE may determine a channel estimate of a communications channel between itself and the eNB (H), as well as interference information for the communications channel (R) (block 407). The UE may determine H and R by measuring pilot signals, reference signals, and the like, transmitted by the eNB. According to an alternative example embodiment, the LDS signature matrix may be predefined, by a technical standard or an operator of a communications system that includes the UE, for example, and is pre-loaded into the UE.

The UE may derive post-processing SINR values for each number of layers for a communications channel up to the maximum number of layers supported for communications (block 409). According to an example embodiment, the UE may derive N post-processing SINR values where N is the maximum number of layers supported for communications. According to an alternative example embodiment, the UE may derive a subset of the N possible post-processing SINR values. The UE may select a LDS CQI vector (comprising a MCS and a number of layers) in accordance with the post-processing SINR values (block 411) and transmit the LDS CQI vector to the eNB (block 413).

According to an example embodiment, the UE may provide the LDS CQI vector to the eNB through dynamic signaling. The dynamic signaling may be based on the receipt of a feedback request from the eNB. Alternatively, the UE may periodically report the LDS CQI vector to the eNB in accordance with a reporting schedule specified by the eNB, for example.

FIG. 4b illustrates a flow diagram of example operations 450 occurring in an eNB as the eNB participates in link adaptation. Operations 450 may be indicative of operations occurring in an eNB, such as eNB 305, as the eNB participates in link adaptation.

Operations 450 may begin with the eNB transmitting a LDS signature matrix (block 455). According to an example embodiment, the eNB may transmit the LDS signature matrix to a UE when the UE attaches with the eNB. Additionally, if the eNB makes changes to the LDS signature matrix, the eNB may transmit the changes to the UE. According to an alternative example embodiment, the LDS signature matrix may be predefined and pre-loaded into the UE. The eNB may receive a LDS CQI vector from the UE (block 457). The LDS CQI vector may include a MCS and a number of layers selected for a communications channel between the eNB and the UE by the UE in accordance with post-processing SINR values derived by the UE.

The eNB may adjust the LDS CQI vector with information about the condition of the communications system not known by the UE to produce an adjusted LDS CQI vector (block 459). As an illustrative example, the information used by the eNB to adjust the LDS CQI vector may include open-loop link adaptation information, UE pairing information, power allocation information, and the like. If the communications system uses LDS, the eNB may transmit the adjusted LDS CQI vector to the UE (block 463). If the communications system uses SCMA, the eNB may further adjust the LDS CQI vector by mapping the adjusted LDS CQI vector to a SCMA CQI vector (block 461) and transmit the SCMA CQI vector to the UE (block 463).

According to an example embodiment, the eNB may transmit the LDS signature information to the UE(s) using static or semi-static signaling. The SCMA CQI vector (and/or the LDS CQI vector) may be transmitted to a UE (such as a UE scheduled by the eNB) by dynamic control signaling. Similarly, for CQI feedback operation, slow signaling such as OFDMA based or SCMA based signaling may be used. It is noted that LDS signaling may be performed without the need of LDS to SCMA mapping.

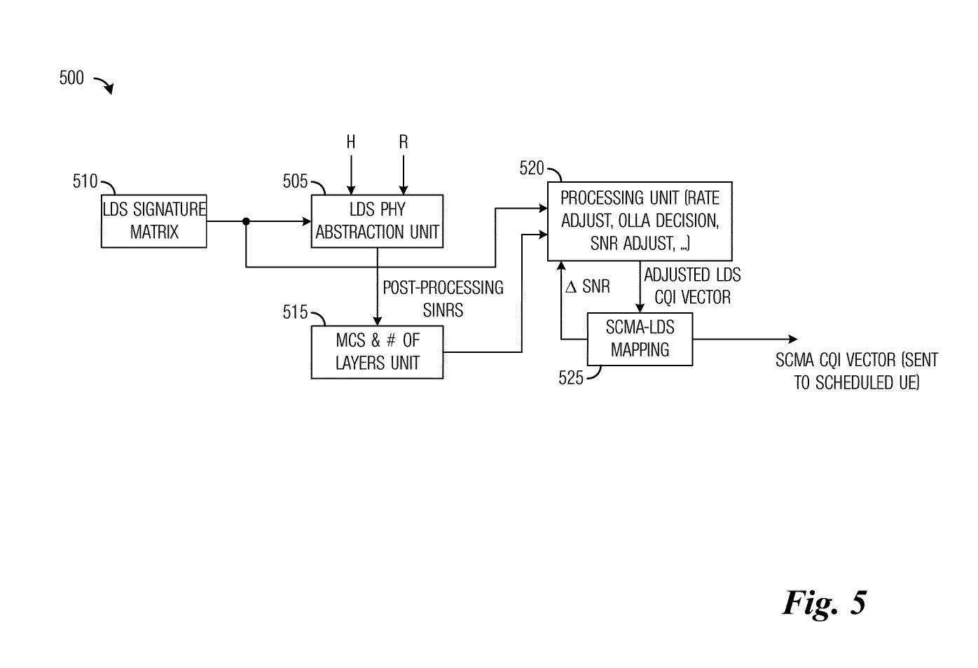

FIG. 5 illustrates a detailed view of an example LDS and/or SCMA link adaptation system 500 for a TDD communications system. Since downlink communications channels and uplink communications channels in a TDD communications occur in the same frequency bands separated in time, the communications channels may very likely have identical (or at the least, very similar) channel conditions. Therefore, it may be possible for the eNB (or UE) to obtain the channel estimate of a first communications channel (e.g., a downlink communications channel) by measuring and estimating a second communications channel (e.g., an uplink communications channel) and utilizing channel reciprocity. Hence, the UE may not be needed to obtain H and R of the communications channel.

According to an example embodiment, a LDS PHY abstraction unit 505 in an eNB, for example, may obtain H and R for a communications channel by measuring transmissions made by a UE. As an illustrative example, the eNB may measure transmissions of reference signals, and the like, transmitted by the UE to estimate the communications channel and obtain the interference information. LDS PHY abstraction unit 505 may derive post-processing SINR values from H and R, as well as LDS signature information stored in LDS signature matrix 510. A MCSU 515 may select a LDS CQI vector in accordance with the post-processing SINR values.

A processing unit 520 may adjust the LDS CQI vector provided by MCSU 515. The adjustment performed by processing unit 520 may utilize information regarding operating conditions, including open-loop link adaptation information, UE pairing information, power allocation information, and the like. If the communications system uses LDS, the adjusted LDS CQI vector may be provided to the UE to assist the UE improve its decoding performance. If the communications system uses SCMA, the adjusted LDS CQI may be provided to a SCMA-LDS mapping unit 525 to map the adjusted LDS CQI vector to a SCMA CQI vector. The SCMA CQI vector may be provided to the UE. SCMA-LDS mapping unit 525 may be implemented using a LUT, such as ones shown in FIGS. 2b and 2c.

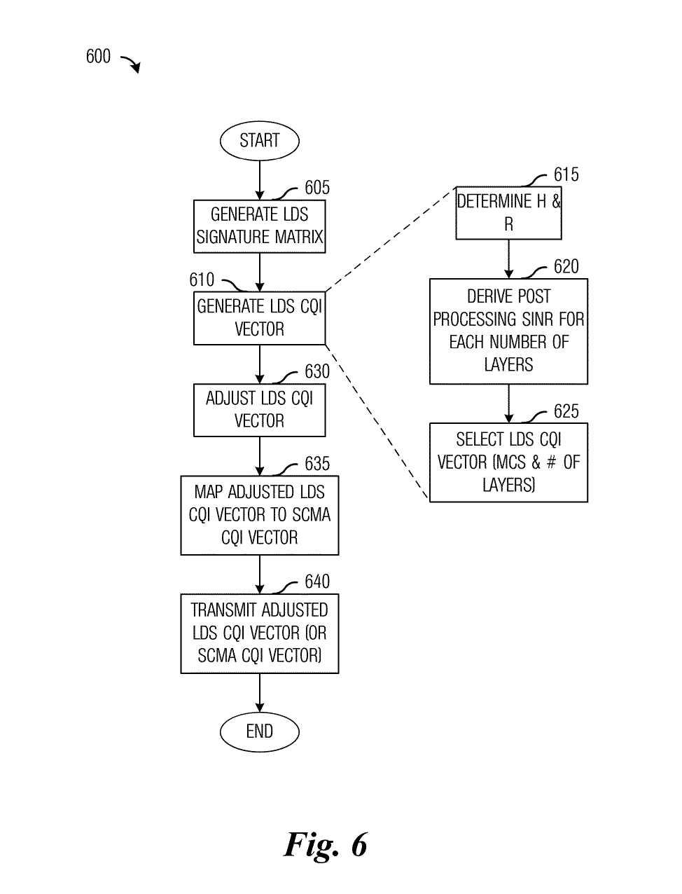

FIG. 6 illustrates a flow diagram of example operations 600 occurring in an eNB as the eNB performs link adaptation in a TDD communications system. Operations 600 may be indicative of operations occurring in an eNB including a link adaptation system as the eNB performs link adaptation in a TDD communications system.

Operations 600 may begin with the eNB generating a LDS signature matrix (block 605). The eNB may generate the LDS signature matrix upon startup of the communications system or when a change is made to the LDS signature matrix. The eNB may generate a LDS CQI vector (block 610). The LDS CQI vector may include a MCS and a number of layers for a communications channel between the eNB and a UE. The generation of the LDS CQI vector may include the eNB determining H and R for the communications channel by measuring a reciprocal communications channel (block 615). The eNB may derive post-processing SINR values for each number of layers for a communications channel up to the maximum number of layers supported for communications (block 620). As discussed previously, the eNB may derive the post-processing SINR values for a subset of the layers. The eNB may select the LDS CQI vector in accordance with the post-processing SINR values (block 625).

The eNB may adjust the LDS CQI vector using information regarding the operating condition (block 630). As an illustrative example, the information used by the eNB to adjust the LDS CQI vector may include open-loop link adaptation information, UE pairing information, power allocation information, and the like. If the communications system uses LDS, the eNB may transmit the adjusted LDS CQI vector to the UE (block 640). If the communications system uses SCMA, the eNB may further adjust the LDS CQI vector by mapping the adjusted LDS CQI vector to a SCMA CQI vector (block 635) and transmit the SCMA CQI vector to the UE (block 640).

According to an example embodiment, the LDS signature information and LDS to SCMA mapping (e.g., the LUT shown in FIGS. 2b and 2c) may be stored in the eNB (as well as other communications devices). Multiple versions may be available to meet different operating conditions, spreading factors, and the like. Signaling from the eNB to the UE may involve the eNB transmitting the SCMA CQI vector (or the LDS CQI vector) to the UE using dynamic control signaling. It is noted that UE to eNB signaling may not be required.

According to an example embodiment, a table may be used to help reduce communications overhead involved in signaling the CQI vectors. A table (or list, ordered list, and the like) of CQI vectors, indexed by post-processing SINRs, may be stored at both a transmitting device and a receiving device. The table, which may be referred to as a link adaptation table, may be used to store parameters, including number of layers, and MCS level. The transmitting device may transmit an index to the table, which indicates the parameters, e.g., the number of layers and the MCS level, of the link for the receiving device, to the receiving device. The receiving device may use the index to determine the parameters, e.g., the number of layers and the MCS level.

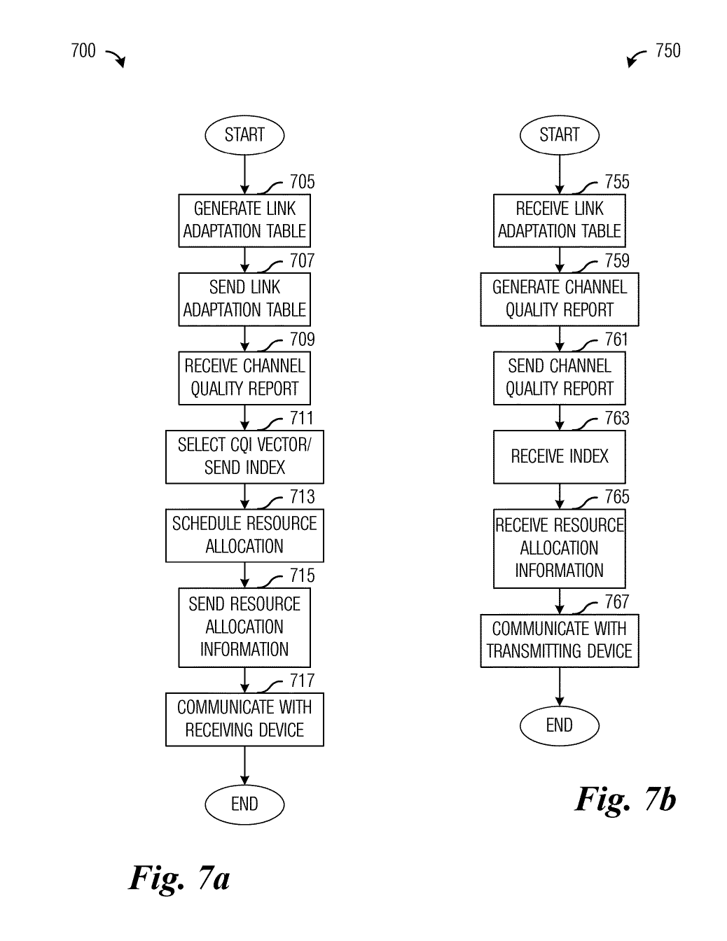

FIG. 7a illustrates a flow diagram of example operations 700 occurring in a transmitting device as the transmitting device communicates with a receiving device. Operations 700 may be indicative of operations occurring in a transmitting device, such as an eNB, as the transmitting device communicates with a receiving device, such as a UE.

Operations 700 may begin with the transmitting device generating a link adaptation table (block 705). The link adaptation table may include information related to link adaptation. As an illustrative example, the link adaptation table may include parameters such as number of layers, and MCS level. The link adaptation table may be indexed in accordance with post-processing SINR values. The transmitting device may send the link adaptation table to the receiving device (block 707). As an illustrative example, the transmitting device may provide the link adaptation table to the receiving device when the receiving device attaches to the transmitting device. According to an alternative example embodiment, the link adaptation table may be defined a priori and stored in the transmitting device and the receiving device for subsequent use. In such a situation, the transmitting device may not need to generate the link adaptation table nor send the link adaptation table to the receiving device. According to another alternative example embodiment, the link adaptation table may be stored in a remote database and the transmitting device may retrieve the link adaptation table from the remote database.

The transmitting device may receive a channel quality report from the receiving device (block 709). The channel quality report may be generated by the receiving device in accordance with the link adaptation table. The transmitting device may use the channel quality report to derive post-processing SINR values, select a CQI vector that includes the parameters stored in the link adaptation table (where the selection is in accordance with the post-processing SINR values, for example), and send an indicator of the selected CQI vector (e.g., the post-processing SINR values) to the receiving device (block 711). The transmitting device may schedule a resource allocation (block 713) and send information related to the resource allocation to the receiving device (block 715). The transmitting device may communicate with the receiving device (block 717)

FIG. 7b illustrates a flow diagram of example operations 750 occurring in a receiving device as the receiving device communicates with a transmitting device. Operations 750 may be indicative of operations occurring in a receiving device, such as a UE, as the receiving device communicates with a transmitting device, such as an eNB.

Operations 750 may begin with the receiving device receiving a link adaptation table from the transmitting device (block 755). The link adaptation table may include information related to link adaptation. As an illustrative example, the link adaptation table may include parameters such as number of layers, and MCS level. The link adaptation table may be indexed in accordance with post-processing SINR values. According to an example embodiment, the link adaptation table may be defined a priori and stored in the transmitting device and the receiving device for subsequent use. In such a situation, the receiving device may not need to receive the link adaptation table.

The receiving device may generate a channel quality report for a communications channel between the transmitting device and the receiving device (block 759) and send the channel quality report to the transmitting device (block 761). The channel quality report may be transmitted using information in the link adaptation table. The receiving device may receive an index to the link adaptation table (block 763). The index may be an indicator of an entry in the link adaptation table and the parameters stored in the entry, e.g., a number of layers and a MCS level, may be parameters of the communications channel between the transmitting device and the receiving device. The transmitting device may have selected the entry in accordance with the channel quality report transmitted by the receiving device. The receiving device may receive information about a resource allocation from the transmitting device (block 765). The information about the resource allocation may specify a network resource allocated to a transmission on the communications channel. The receiving device may communicate with the transmitting device in accordance with the information about the resource allocation (block 767).

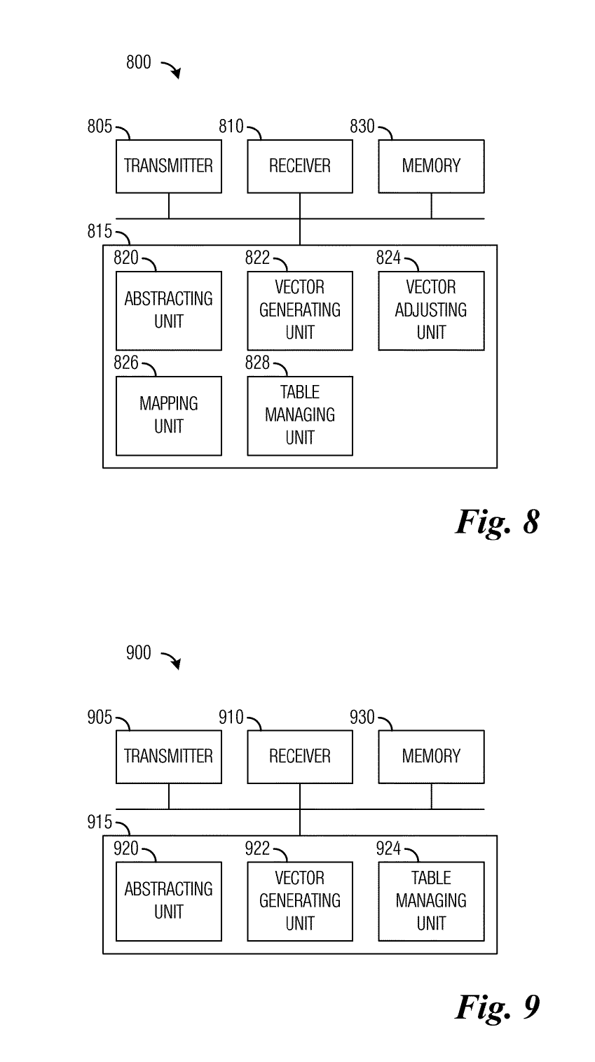

FIG. 8 illustrates an example first communications device 800. Communications device 800 may be an implementation of transmitting device, such as an eNB in a downlink communications channel or a UE in an uplink communications channel. Communications device 800 may be used to implement various ones of the embodiments discussed herein. As shown in FIG. 8, a transmitter 805 is configured to transmit LDS signature information, LDS CQI vectors, SCMA CQI vectors, pilot signals, reference signals, packets, CQI vector indicators, and the like. Communications device 800 also includes a receiver 810 that is configured to receive LDS CQI vectors, packets, and the like.

An abstracting unit 820 is configured to derive post-processing SINR values for each number of layers for a communications channel up to the maximum number of layers supported for communications. Abstracting unit 820 is configured to derive post-processing SINR values for a subset of the number of layers. Abstracting unit 820 utilizes H and R for the communications channel, as well as LDS signature information. A vector generating unit 822 is configured to select a LDS CQI vector in accordance with the post-processing SINR values. A vector adjusting unit 824 is configured to adjust the LDS CQI vector using information regarding the operating condition of the communications system. A mapping unit 826 is configured to map the LDS CQI vector to a SCMA CQI vector. Mapping unit 826 is configured to perform the mapping using a LUT. A table managing unit 828 is configured to save a vector (e.g., a LDS CQI vector, a SCMA CQI vector) in a memory 830, in a table form, for example. Table managing unit 828 is configured to generate an index or indicator (e.g., a CQI vector indicator) corresponding to a LDS CQI vector or a SCMA CQI vector selected in accordance with the post-processing SINR values. Memory 830 is configured to store H, R, post-processing SINR values, LDS signature information, LDS CQI vectors, adjusted LDS CQI vectors, SCMA CQI vectors, and the like.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, receiver 810 and transmitter 805 may be implemented as a specific hardware block, while abstracting unit 820, vector generating unit 822, vector adjusting unit 824, mapping unit 826, and table managing unit 828 may be software modules executing in a microprocessor (such as processor 815) or a custom circuit or a custom compiled logic array of a field programmable logic array. Abstracting unit 820, vector generating unit 822, vector adjusting unit 824, mapping unit 826, and table managing unit 828 may be modules stored in memory 830.

FIG. 9 illustrates an example second communications device 900. Communications device 900 may be an implementation of a receiving device, such as a UE in a downlink communications channel or an eNB in an uplink communications channel. Communications device 900 may be used to implement various ones of the embodiments discussed herein. As shown in FIG. 9, a transmitter 905 is configured to LDS CQI vectors, reference signals, packets, and the like. Communications device 900 also includes a receiver 910 that is configured to receive LDS signature information, pilot signals, packets, CQI vector indicators, and the like.

An abstracting unit 920 is configured to derive post-processing SINR values for each number of layers for a communications channel up to the maximum number of layers supported for communications. Abstracting unit 920 is configured to derive post-processing SINR values for a subset of the number of layers. Abstracting unit 920 utilizes H and R for the communications channel, as well as LDS signature information. A vector generating unit 922 is configured to select a LDS CQI vector in accordance with the post-processing SINR values. A table managing unit 924 is configured utilize a table of CQI vectors to retrieve a CQI vector in accordance with a received indicator of a CQI vector. A memory 930 is configured to store H, R, post-processing SINR values, LDS signature information, LDS CQI vectors, and the like.

The elements of communications device 900 may be implemented as specific hardware logic blocks. In an alternative, the elements of communications device 900 may be implemented as software executing in a processor, controller, application specific integrated circuit, or so on. In yet another alternative, the elements of communications device 900 may be implemented as a combination of software and/or hardware.

As an example, receiver 910 and transmitter 905 may be implemented as a specific hardware block, while abstracting unit 920, vector generating unit 922, and table managing unit 924 may be software modules executing in a microprocessor (such as processor 915) or a custom circuit or a custom compiled logic array of a field programmable logic array. Abstracting unit 920, vector generating unit 922, and table managing unit 924 may be modules stored in memory 930.

Although the present disclosure and its advantages have been described in detail, it should be understood that various changes, substitutions and alterations can be made herein without departing from the spirit and scope of the disclosure as defined by the appended claims.

What is claimed is:

1. A method for link adaptation in a wireless communications system, the method comprising:
deriving, by a first communications device, a range of post-processing signal to interference plus noise ratio (SINR) values for a communications channel using a first layer in the communications channel available for communications, the range of post-processing SINR values derived in accordance with a channel estimate of the communications channel, interference information about the communications channel, and signature information;
selecting, by the first communications device, a modulation and coding scheme (MCS) in accordance with the range of post-processing SINR values to establish a first channel quality index (CQI) vector;
adjusting, by the first communications device, the first CQI vector in accordance with information regarding operating conditions in the wireless communications system to produce an adjusted CQI vector; and
transmitting, by the first communications device, the adjusted CQI vector to a second communications device.

2. The method of claim 1, wherein adjusting the first CQI vector further comprises:
mapping the adjusted CQI vector to a sparse code multiple access (SCMA) CQI vector; and
setting the SCMA CQI vector as the adjusted CQI vector.

3. The method of claim 2, wherein the adjusted CQI vector is mapped using a look-up table.

4. The method of claim 1, wherein the communications channel has a plurality of layers available for communications, and wherein selecting the MCS further includes selecting a layer from the plurality of layers in the communication channel along with the MCS in accordance with the range of post-processing SINR values to establish the first CQI vector.

5. The method of claim 4, wherein deriving the range of post-processing SINR values comprises:
for each of the plurality of layers in the communications channel available for communications,
determining an open-loop capacity for an n-th LDS transmission block, where n is an integer value, and
deriving the range of post-processing SINR values by applying a function to the open-loop capacities.

6. The method of claim 5, wherein determining the open-loop capacity comprises evaluating C_{L}^{open}(n)=log|I+H_{L}(n)R(n)⁻¹H_{L}^{H}(n)|, where H_{L}(n)=diag(h(n))S_{L}, h(n) is a channel vector of allocated orthogonal frequency division multiplexed (OFDM) tones for an n-th low density signature (LDS) block, S_{L} is a first L columns of S, and S is signature information.

7. The method of claim 4, wherein selecting the MCS and the layer from the plurality of layers comprises:
selecting the layer from the plurality of layers in accordance with one of short-term information and long-term geometry; and
selecting the MCS in accordance with an orthogonal frequency division multiple access (OFDMA) MCS table.

8. The method of claim 1, wherein the adjusted CQI vector is transmitted using dynamic control signaling.

9. A method for operating a first communications device, the method comprising:
deriving, by the first communications device, a range of post-processing signal plus interference to noise ratio (SINR) values for a communications channel using a first layer in the communications channel available for communications, the range of post-processing SINR values derived in accordance with a channel estimate of the communications channel, interference information about the communications channel, and signature information;
selecting, by the first communications device, a modulation and coding scheme (MCS) in accordance with the range of post-processing SINR values to establish a first channel quality index (CQI) vector; and
transmitting, by the first communications device, the first CQI vector to a second communications device.

10. The method of claim 9, wherein the communications channel has a plurality of layers available for communications, and wherein selecting the MCS further includes selecting a layer from the plurality of layers in the communication channel along with the MCS in accordance with the range of post-processing SINR values to establish the first CQI vector.

11. The method of claim 9, further comprising receiving the signature information from the second communications device.

12. The method of claim 9, further comprising receiving a second CQI vector from the second communications device, wherein the second CQI vector comprises one of a third CQI vector adjusted in accordance with operating information and a fourth CQI vector mapped from the third CQI vector.

13. The method of claim 9, wherein the first communications device comprises a user equipment.

14. A method for operating a second communications device, the method comprising:
receiving, by the second communications device, a first channel quality index (CQI) vector including a modulation and coding scheme (MCS) of a communications channel between the second communications device and a first communications device;
adjusting, by the second communications device, the first CQI vector in accordance with information regarding operating conditions in a wireless communications system to produce an adjusted CQI vector; and
transmitting, by the second communications device, the adjusted CQI vector to the first communications device.

15. The method of claim 14, wherein the first CQI vector further comprises a layer from a plurality of layers of the communications channel available for communications, and wherein adjusting the first CQI vector further comprises adjusting the layer in accordance with the information regarding the operating conditions in the wireless communications system.

16. The method of claim 14, wherein adjusting the first CQI vector further comprises:
mapping the adjusted CQI vector to a sparse code multiple access (SCMA) CQI vector; and
setting the SCMA CQI vector as the adjusted CQI vector.

17. The method of claim 14, further comprising transmitting signature information to the first communications device.

18. The method of claim 14, wherein the second communications device comprises an evolved NodeB.

19. A method for link adaptation in a wireless communications system, the method comprising:
receiving, by a first communications device, a channel quality report from a second communications device;
selecting, by the first communications device, an entry from a link adaptation table in accordance with the channel quality report, wherein the link adaptation table includes a plurality of entries for channel parameters, and wherein the channel parameters include a number of layers and modulation and coding scheme (MCS) levels; and
communicating, by the first communications device, with the second communications device in accordance with the selected entry.

20. The method of claim 19, further comprising retrieving the link adaptation table from a memory in the first communications device.

21. The method of claim 19, further comprising retrieving the link adaptation table from a remote database.

22. The method of claim 19, further comprising:
generating the link adaptation table; and
transmitting the link adaptation table to the second communications device.

23. The method of claim 19, further comprising transmitting a first indicator of the selected entry to the second communications device.

24. The method of claim 23, wherein the link adaptation table is indexed by post-processing signal plus interference to noise ratio (SINR) values, and wherein the first indicator comprises a post-processing SINR value.

25. The method of claim 19, further comprising:
scheduling, by the first communications device, a resource allocation in accordance with the selected entry; and
transmitting, by the first communications device, a second indicator of the resource allocation to the second communications device.

26. The method of claim 19, wherein the channel quality report is generated in accordance with the link adaptation table.

27. The method of claim 19, further comprising defining, by the first communications device, the link adaptation table.

28. The method of claim 19, wherein the first communications device is an evolved NodeB, and wherein the second communications device is a user equipment.

29. A communications device comprising:
a processor configured to derive a range of post-processing signal to interference plus noise ratio (SINR) values for a communications channel using a first layer in the communications channel available for communications, the range of post-processing SINR values are derived in accordance with a channel estimate of the communications channel, interference information about the communications channel, and signature information, to select a modulation and coding scheme (MCS) in accordance with the range of post-processing SINR values to establish a first channel quality index (CQI) vector, and to adjust the first CQI vector in accordance with information regarding operating conditions in a wireless communications system to produce an adjusted CQI vector; and
a transmitter operatively coupled to the processor, the transmitter configured to transmit the adjusted CQI vector to a second communications device.

30. The communications device of claim 29, wherein the processor is configured to map the adjusted CQI vector to a sparse code multiple access (SCMA) CQI vector, and to set the SCMA CQI vector as the adjusted CQI vector.

31. The communications device of claim 29, wherein the communications channel has a plurality of layers available for communications, and wherein the processor is configured to select a layer from the plurality of layers in the communications channel along with the MCS in accordance with the range of post-processing SINR values to establish the first CQI vector.

32. The communications device of claim 31, wherein the processor is configured to, for each of layers in the communications channel available for communications, determine an open-loop capacity for an n-th LDS transmission block, where n is an integer value, and derive the range of post-processing SINR values by applying a function to the open-loop capacities.

33. The communications device of claim 32, wherein the processor is configured to evaluate C_{L}^{open}(n)=log|I+H_{L}(n)R(n)⁻¹H_{L}^{H}(n)|, where H_{L}(n)=diag(h(n))S_{L}, h(n) is a channel vector of allocated orthogonal frequency division multiplexed (OFDM) tones for an n-th low density signature (LDS) block, S_{L} is a first L columns of S, and S is signature information.

34. The communications device of claim 31, wherein the processor is configured to select the the layer from the plurality of layers in accordance with one of short-term information and long-term geometry, and to select the MCS in accordance with an orthogonal frequency division multiple access (OFDMA) MCS table.

35. The communications device of claim 29, wherein the transmitter is configured to transmit the adjusted CQI vector using dynamic control signaling.
